(19) United States
(12) Patent Application Publication
(10) Pub. No.: US 2008/0150979 A1
(43) Pub. Date: Jun. 26, 2008

(54) INK JET PRINTING APPARATUS AND INK JET PRINTING METHOD

(75) Inventors: Tsuyoshi Shibata, Yokohama-shi (JP); Satoshi Wada, Machida-shi (JP); Hiromitsu Yamaguchi, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/956,621

(22) Filed: Dec. 14, 2007

(30) Foreign Application Priority Data
Dec. 22, 2006 (JP) 2006-346359

(51) Int. Cl. B41J 29/38

(52) U.S. Cl. 347/9

(57) ABSTRACT

An ink jet printing method is provided, in which “color banding” and “time different unevenness” are solved simultaneously, and bidirectional multi-pass printing can be achieved with a small number of multi-passes. Thus, part of a plurality of groups, which are formed by dividing a nozzle row of a print head with the number of multi-passes, is set to be in a nonuse state (or low allowable rate of printing) in a predetermined scanning direction so as to perform printing, while a mask pattern to be used in a forward scan and a backward scan is suitably changed. Therefore, it becomes possible to unify the orders of providing inks (the orders of printing), and the print timings at a plurality of print scans, between contiguous print regions, and even all over the print regions.

### BACKGROUND OF THE INVENTION

1. Field of the Invention

The present invention relates to an ink jet printing apparatus and an ink jet printing method in which an image is printed using an ink containing a color material. The invention relates particularly to a multi-pass printing method in which an image is completed stepwise while scanning a print medium in a reciprocating manner with an ink jet print head having an alignment of ejection openings (nozzles) arranged.

2. Description of the Related Art

Along with the wide spread of copying apparatuses as well as information processing apparatuses such as computers, and further of communication devices as well as communication environments, digital image output apparatuses adopting ink jet printing systems have rapidly spread as a type of printing apparatus for the above-described apparatuses or devices. Particularly, in a serial ink jet printing apparatus, which is the most common among such digital image output apparatuses, a print head is used in which multiple nozzle rows having multiple nozzles arranged to eject ink are provided for respective ink colors. An image is sequentially formed by intermittently repeating a main printing scan in which ink is ejected while a print medium is scanned by a print head, and a sub-scan in which a print medium is fed by a predetermined amount in a direction intersecting with the main printing scan.

With respect to color images to be outputted from an ink jet printing apparatus, color performance, gradient, and uniformity are important. In particular, it is known that the uniformity is susceptible to small unevenness for each nozzle occurring in the manufacturing of print heads. Unevenness in manufacturing each nozzle causes unevenness in an amount of ejection and a direction of ejection at the time of printing. As a result, stripes and density unevenness occur on images. To solve image deterioration due to such unevenness for each nozzle, a multi-pass printing method has heretofore been adopted.

With respect to multi-pass printing, in a printable image region during one print scan by a print head, print scans and sub-scans are alternately repeated multiple times. In this way, an image is completed stepwise (for example, refer to: U.S. Pat. No. 4,748,453; Japanese Patent Laid-Open No. sho 58-194541; and Japanese Patent Laid-Open No. sho 55-113573). Accordingly, a line which extends in a main scan direction and which is printable by one nozzle is formed by multiple nozzles. As a result, even when each nozzle has unevenness in the amount of ejection or in the direction of ejection, such a characteristic of unevenness does not concentrate on one portion, so that an image, which is excellent in uniformity, is achieved. Therefore, the effect of such a multi-pass printing method becomes high as the number of multi-passes, i.e. the number of print scans required for completing a single image region, becomes large.

However, the multi-pass printing has a disadvantage. Since multiple print scans need to be performed over a single image region, a larger amount of printing time is spent. In other words, as the number of multi-passes is increased, image quality is enhanced, but the throughput is reduced. This fact shows that the image quality and the throughput are in the relationship of tradeoff.

Even in a case where the same number of multi-passes is assumed to be used for printing, in order to improve the throughput even a little bit, a bidirectional multi-pass printing method is performed. In this method, printing is performed by both of a forward scan and a backward scan. In this case, however, adverse effects such as “color banding” and “time difference unevenness” newly occur. “Color banding” and “time difference unevenness” are specifically described below.

FIG. 15 is a schematic view showing for explaining an example of a nozzle arrangement of an ink jet print head which is applicable to a serial type ink jet printing apparatus. In a print head 2801, nozzle rows 2802, on each of which ejection openings 2803 ejecting ink are arranged in plural as shown in the drawing, are arranged in parallel for four colors in a main scan direction. When performing printing, the print head 2801 ejects ink through each of the ejection openings 2803, while moving in the main scan direction. In this case, by the forward scan, ink is provided to a print medium in the order of cyan→magenta→yellow→black. By the backward scan, ink is provided to the print medium in the order of black→yellow→magenta→cyan, i.e. ink is provided in the order opposite to that of the forward scan.

FIG. 6 is a schematic view showing a print state of a print head at a time when bidirectionally performing multi-pass printing with three passes by using the above-described print head 2801 in order to explain the color banding. FIG. 7 is a schematic view showing a printing state of a print medium at a time when performing the same printing. In both drawings, relative positions to fixed printing media in the sub-scan direction of the print head 2801 are shown.

In the case of the multi-pass printing with three passes, referring to FIG. 6, a nozzle region of the print head 2801 can be considered with the nozzle region divided into three blocks. During a first print scan to be performed by the forward scan, ink is provided to the print medium in the order of cyan→magenta→yellow→black, by a region of the front one-third of the print head. Following a feeding operation by an amount corresponding to a region of one-third thereof, during a second print scan to be subsequently performed by the backward scan, ink is provided to the print medium in the order of black→yellow→magenta→cyan, by a region of the front two-thirds of the print head. Following a further feeding operation by the amount corresponding to a region of one-third thereof, during a third print scan to be performed by the forward scan again, ink is provided to the print medium in the order of cyan→magenta→yellow→black by the entire region of the print head. As described above, a main print scan to be performed during the forward scan or during the backward scan, and a feeding operation by the amount corresponding to a region of one-third thereof are alternately repeated, so that an image is sequentially formed in an image region of the print medium.

Paying attention to a print region A in a print medium with reference to FIG. 7, it can be seen that an image is formed in this region in the order of the forward scan the backward scan the forward scan. In addition, paying attention to a print region B contiguous to the print region A, it can be seen that an image is formed in this region in the order of the backward scan the forward scan the backward scan. In the same manner, a region in which printing is performed in the same order as that of the print region A, and a region in which printing is performed in the same order as that of the print region B are arranged alternately in the sub-scan direction.

In the ink jet printing method, it is known in general that a color provided, which precedes the others, tends to be a preferential color (surpassing in color performance). For example, when printing a uniformly green image by printing 50% cyan and 50% yellow, the cyan color, the printing of which precedes the printings of the yellow color, tends to be the preferential color in the region A in which the forward scan is first performed. On the other hand, in the region B in which the backward scan is first performed, the yellow color, the printing of which precedes the printings of the cyan color, tends to be the preferential color. As a result, for images to be outputted, a bluish-green region (print region A) in which the cyan color is preferential, and a yellowish-green region (print region B) in which the yellow color is preferential, are alternately arranged in the sub-scan direction, hence presenting an image problem referred to as “color banding.”

Next, the “time difference unevenness” is described. FIG. 8 is a schematic view showing a printing state at a time when performing bidirectional multi-pass printing in the form of two passes using the above-described print head 2801 in order to explain the “time difference unevenness.” Hereinafter, a description is given for the case where a uniformly black image is printed.

In the case of bidirectional multi-pass printing with two passes, a nozzle region of the print head 2801 can be considered with the nozzle region divided into two blocks. During the first print scan by the forward scan, black ink is provided by a region of the front half of the print head. Thereafter, following a feeding operation by the amount corresponding to a printed half region, during the second print scan being the backward scan, black is provided to the print medium by the entire region of the print head. During the third print scan following a feeding operation by the amount corresponding to the region of half thereof, black ink is again provided by the entire region of the print head. As described above, a main print scan of black ink to be performed by the forward scan or by the backward scan, and a feeding operation by the amount corresponding to a region of half thereof are alternately repeated, so that a black image is sequentially formed in an image region of the print medium.

At this point, paying attention to the left side to the print region A on the print medium, it can be seen that the forward scan is performed using the print head, and after scans for one reciprocating scan are performed, i.e. at the end at which the remaining forward scan, a reverse operation, and the backward scan are performed, ink is provided to the above-described region by the backward scan. In other words, a period of time between the first print scan to the above-described region and the second print scan thereto is comparatively long. In contrast, paying attention to the left to the print region B, it can be seen that the backward scan is performed over this region, and, immediately after the print head is reversed, ink is provided by the forward scan. In other words, a period of time between the first print scan to the above-described region and the second print scan thereto is comparatively short. As described above, in a left region of the print medium, a region in which main print scans are performed twice with a comparatively long period of time as in the case of the print region A, and a region in which main print scans are performed twice within a comparatively short period of time as in the case of the print region B are alternately arranged in the sub-scan direction. On the other hand, in a right region of the print medium, two print scans over the print region A are performed within a comparatively short period of time, while the scans over the print region B requires a comparatively long period of time. In other words, the regions, conditions of which are reversed from those of the left region, are alternately arranged in the sub-scan direction.

FIGS. 14A to 14C are schematic views for explaining an influence exerted on an image due to a time difference between such two print scans. FIG. 4A shows a plan view and a sectional view of a print medium in the case where one cyan dot is printed on the print medium being blank. FIG. 14B shows a state in which a cyan dot is printed over a magenta dot, having been printed, within a comparatively short period of time. FIG. 14C shows a state in which a magenta dot is printed, and after a comparatively long period of time has elapsed since the printing of the magenta dot, a cyan dot is printed over the magenta dot. In general, the degree of infiltration of a dot newly printed in a region of a print medium is influenced by the degree of wetting in the region. More specifically, in the state of FIG. 14B in which the magenta dot is printed, and, thereafter, the cyan dot is printed within a comparatively short period of time, since the print medium is wet because of the printed magenta dot, the cyan ink is infiltrated in the depth direction, so that the cyan ink unlikely remains on the surface, and its color performance is also low. On the other hand, in the state of FIG. 14C in which the magenta dot is printed, and after a long period of time has elapsed, the cyan dot is printed over the magenta dot, since the magenta dot comes to a state in which it is fixed on some level, and the print medium is dry, the cyan ink remains on the surface of the print medium on the same level as that of the ink printed on a blank paper, and its color performance is also high.

Although the description has been given above while referring to the cyan dot and the magenta dot as examples, the same is true for the case where an image of a single black color is printed in multi-pass printing using two passes. In other words, an image in a region in which two print scans are performed within a comparatively short period of time is low in density, while an image in a region in which two print scans are performed using a comparatively long period of time is high in density. As a result, the image problem referred to “time difference unevenness” arises in which, as shown in FIG. 8, the region (on the left side of the print region A) having a high black density, and the region (on the left side of the print region B) having a low black density are alternately disposed in the sub-scan direction.

Such “time difference unevenness” can be reduced on some level by setting a large number of multi-passes. However, if an image size is larger, or if a reversing time of carriage is shorter, a difference of condition among image regions is bigger, the “time difference unevenness” can not be removed without substantial throughput degradation.

FIGS. 9 and 10 are schematic views each showing a printing state in which the same image as that of FIG. 8 is printed in multi-pass printing using four passes. Referring to FIG. 9, in the case of bidirectional multi-pass printing with four passes, a nozzle region of the print head 2801 can be considered with the nozzle region divided into four blocks (parts). During a first print scan to be performed by the forward scan, black ink is provided by a region of the front quarter of the print head. Thereafter, following a feeding operation by the amount corresponding to a printed quarter region, during a second print scan being the backward scan, black ink is provided to a print medium by a region of the front half of the print head. Following a further feeding operation by the amount corresponding to a quarter region, during a third print scan, black ink is provided by a region of three quarters of the print head by a forward scan again. Following a further feeding operation by the amount of a quarter region, during a fourth print scan, black ink is provided by the entire region of the print head by a backward scan again. In this manner, a main print scan of black ink to be performed by the forward scan or by the backward scan, and a feeding operation by the amount corresponding to a quarter region are alternately repeated, so that a black image is sequentially formed in an image region of the print medium.

In the multi-pass printing using four passes in which an image is completed by four print scans, time between individual print scans is not constant, sometimes long or sometimes short. Hence, for example, the print region A, in which time between the first print scan and the second print scan is longer, is not necessarily higher in density than the print region B. However, in general, in multi-pass printing with about four passes, it is true that, in many cases, the substantially entire region of a print medium is covered with dots by first two print scans, and density and hue are influenced by the timings of the first two print scans. Therefore, on both ends of an image, regions of two types in which densities and hues are different are disposed alternately. When this is conspicuous, it can be viewed as “time difference unevenness.” Such “time difference unevenness” is detected on both ends of a print region, and its degree tends to increase as a width (i.e., a scan region of a print head) of the print medium becomes large.

By setting the number of passes for multi-pass printing to a large one such as 8 passes or 16 passes, it is possible to visually suppress the “color banding” and “time difference unevenness” to a certain level so that they are made less visible. However, in a case where bidirectional printing is adopted so as to enhance the throughput, an increase of the number of multi-passes is not preferable. For example, contrived methods for suppressing the “color banding” are disclosed in Japanese Patent Laid-Open No. 2001-80093 and U.S. Pat. No. 6,086,181. However, applications of these methods were unable to solve the “time difference unevenness” at the same time.

### SUMMARY OF THE INVENTION

In light of the above-described problems, the present invention has been made, and an object thereof is to provide an ink jet printing method which is capable of simultaneously solving the “color banding” and “time difference unevenness,” and also capable of achieving bidirectional multi-pass printing with a small number of multi-passes.

The first aspect of the present invention is an ink jet printing method in which printing is performed on a print medium using a print head, including a plurality of nozzle rows that correspond to a plurality of kinds of inks, comprising the steps of: causing the print head to scan in the manner of a forward scan and a backward scan; feeding the print medium by a smaller amount of length than a width of the nozzle row between the forward scan and the backward scan; and performing printing in a unit region having a width of the smaller amount on the print medium by performing a plurality of scans including the forward scan and the backward scan while changing the printing orders of the plurality of kinds of inks between the forward scan and the backward scan, wherein nozzles to be used in each of the plurality of scans are changed so that the printing orders of the plurality of kinds of inks are the same in all of a plurality of unit regions that are contiguous in the feeding direction.

The second aspect of the present invention is an ink jet printing method in which a first ink and a second ink are ejected through respective nozzle rows corresponding to the first ink and the second ink, arranged in a scanning direction of a print head, by performing a plurality of scans of the print head, the scans including a forward scan and a backward scan, in a plurality of unit regions on a print medium, comprising the steps of: ejecting inks in an order of the first ink and the second ink through the respective nozzle rows onto the unit region by the forward scan; ejecting inks in an order of the second ink and the first ink through the respective nozzle rows onto the unit region by the backward scan; and feeding the print medium by a width of the unit region between the forward scan and the backward scan, wherein nozzles to be used in each of the plurality of scans are changed so that the printing orders of the first and second inks are the same in any one of the plurality of unit regions.

The third aspect of the present invention is an ink jet printing method in which printing is performed on a print medium using a print head, including a nozzle row in which a plurality of nozzles are arranged, comprising the steps of: dividing the nozzle row into M blocks including some of the nozzles consecutively located (M being a positive integer), and then printing a first unit region among unit regions on the print medium, each of the unit region corresponding to the width of each of the blocks, by performing scans M times including a forward scan and a backward scan; printing a second unit region contiguous to the first unit region by performing scans M times including a forward scan and a backward scan; and feeding the print medium by the width of the block between the forward scan and the backward scan, wherein the first unit region is printed by performing scans M−1 times among the scans to be performed M times, using nozzles contained in M−1 blocks starting from one end of the nozzle row, and the second unit region is printed by performing scans M−1 times among the scans to be performed M times, using nozzles contained in M−1 blocks starting from the other end of the nozzle row.

The forth aspect of the present invention is an ink jet printing apparatus in which printing is performed in a unit region on a print medium, the unit region having a smaller width than that of a nozzle row included in a print head, by performing a plurality of scans, including a forward scan and a backward scan, using the print head, comprising: scanning means which causes the print head to perform forward and backward scans; and feeding means which feeds the print medium by a smaller amount of length than the width of the nozzle row between the forward and backward scans, wherein, the order of a forward scan with printing and a backward scan with printing in a first unit region of the unit regions, and the number of scans with printing in the first unit region are the same as those in a second unit region contiguous to the first unit region.

The fifth aspect of the present invention is an ink jet printing apparatus in which printing is performed in a unit region on a print medium, the unit region having a smaller width than that of a nozzle row included in a print head, by performing a plurality of scans in the unit region using the print head, the scans including a forward scan and a backward scan, comprising: scanning means which causes the print head to be scanned in the manner of the forward and backward scans; and feeding means for feeding the print medium by a smaller amount of length than a width of the nozzle row between the forward and backward scans, wherein a first print mode, and a second print mode in which the number of the plurality of scans is larger than that in the first print mode are executable; wherein in the first print mode, the order of a forward scan with printing and a backward scan with printing in a first unit region, of the unit regions, and the number of scans with printing are the same as those in a second unit region contiguous to the first unit region, and in the second print mode, the order of a forward scan with printing and a backward scan with printing in a first unit region is different from those in the second unit region.

Further features of the present invention will become apparent from the following description of exemplary embodiments (with reference to the attached drawings).

### BRIEF DESCRIPTION OF THE DRAWINGS

FIG. 1 is a block diagram showing configurations of mainly hardware and software of a personal computer (hereinafter, also referred to as a PC) serving as a host device according to an embodiment of the present invention;

FIG. 2 is a block diagram for explaining main data processing in a PC 100 and a printing apparatus 104 when printing is performed by the printing apparatus 104;

FIG. 3 is a perspective view for explaining an inner configuration of the ink jet printing apparatus 104 which is applied to the embodiment thereof;

FIG. 4 is a view for schematically explaining a relationship between a print head, a mask pattern, and a print medium in multi-pass printing with two passes;

FIG. 5 is a schematic view for briefly explaining mechanisms of mask patterns for two passes which complement each other;

FIG. 6 is a schematic view showing a print state of a print head at a time when multi-pass printing with three passes is performed bidirectionally, using the above-described print head 2801 in order to explain color banding;

FIG. 7 is a schematic view showing a print state of a print medium in which the same printing as that of FIG. 6 is performed;

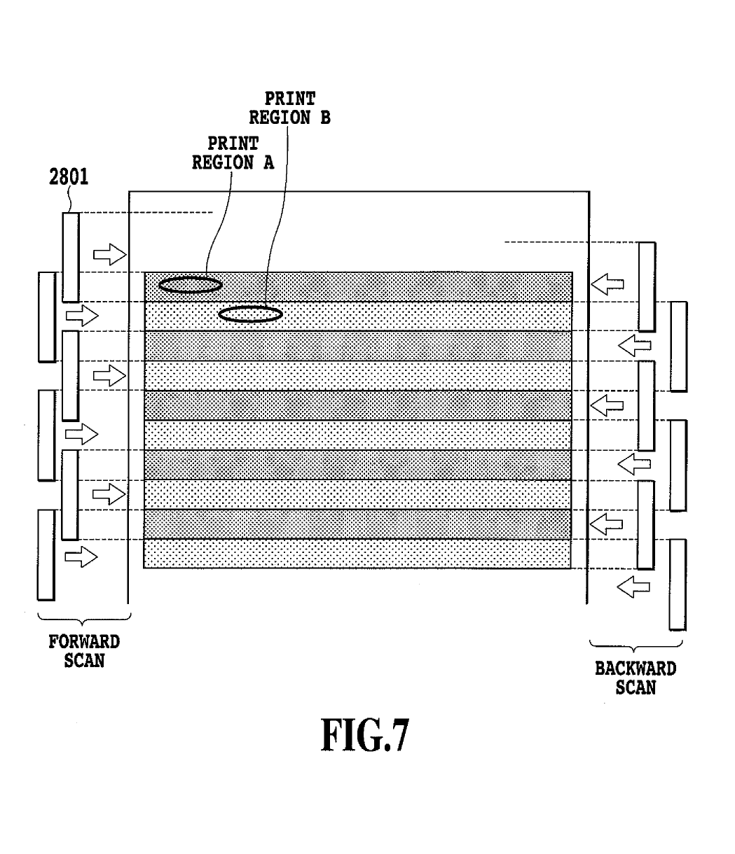

FIG. 8 is a schematic view showing a print state at a time when multi-pass printing with two passes is performed bidirectionally, using the print head 2801 in order to explain “time difference unevenness.”;

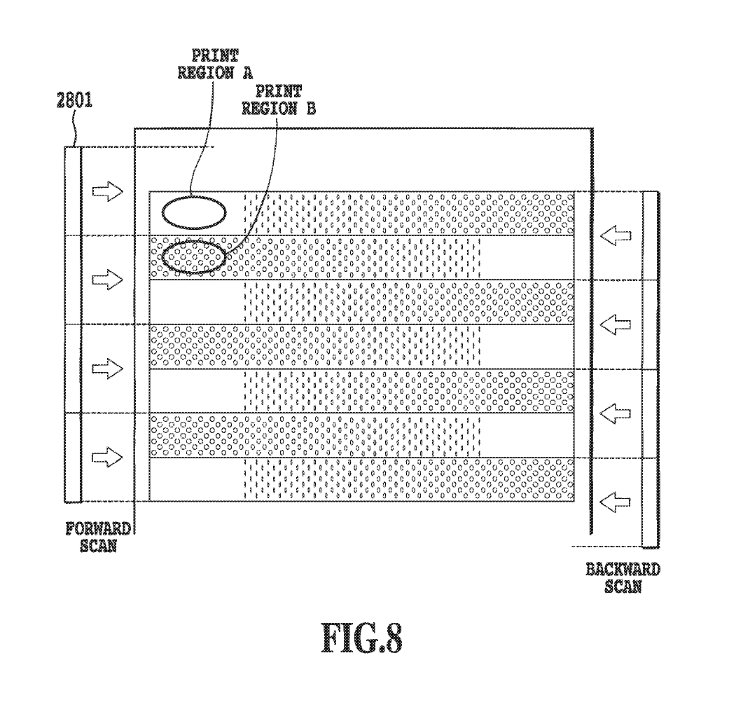

FIG. 9 is a schematic view showing a print state at a time when multi-pass printing with four passes is performed bidirectionally, on the same image as that of FIG. 8;

FIG. 10 is a schematic view showing a print state at a time when multi-pass printing with four passes is performed bidirectionally, on the same image as that of FIG. 8;

FIG. 11 is a schematic view showing a print state of the print head 2801 in a first embodiment at a time when bidirectional multi-pass printing with three passes is performed bidirectionally;

FIG. 12 is a schematic view showing a print state of the print head 2801 in a second embodiment at a time when bidirectional multi-pass printing with four passes is performed bidirectionally;

FIG. 13 is a schematic view showing a print state of the print head 2801 in a third embodiment at a time when bidirectional multi-pass printing with five passes is performed bidirectionally;

FIGS. 14A to 14C are schematic views for explaining an influence exerted on an image due to a time difference between two print scans;

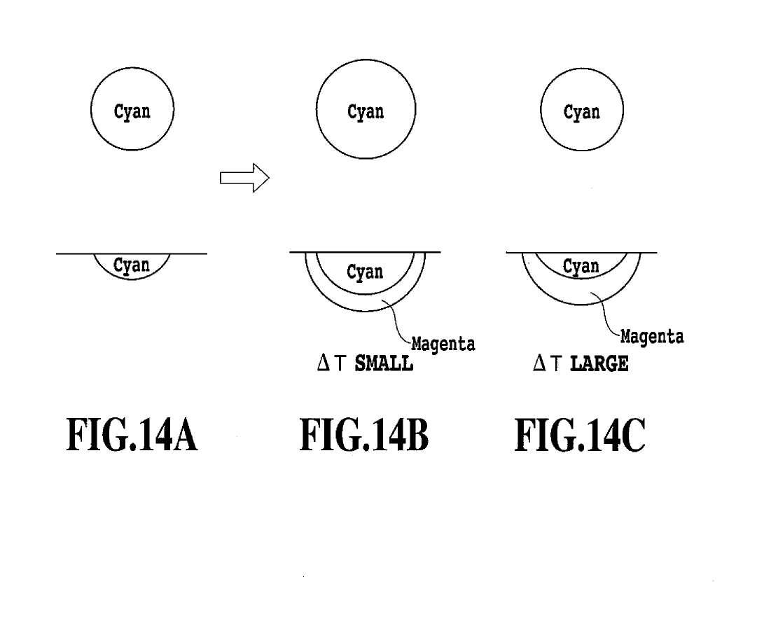

FIG. 15 is a schematic view for explaining a nozzle arrangement state of an ink jet print head which is generally used in a serial type ink jet printing apparatus; and

FIG. 16 is a schematic view for explaining a configuration of a left-right symmetric type print head.

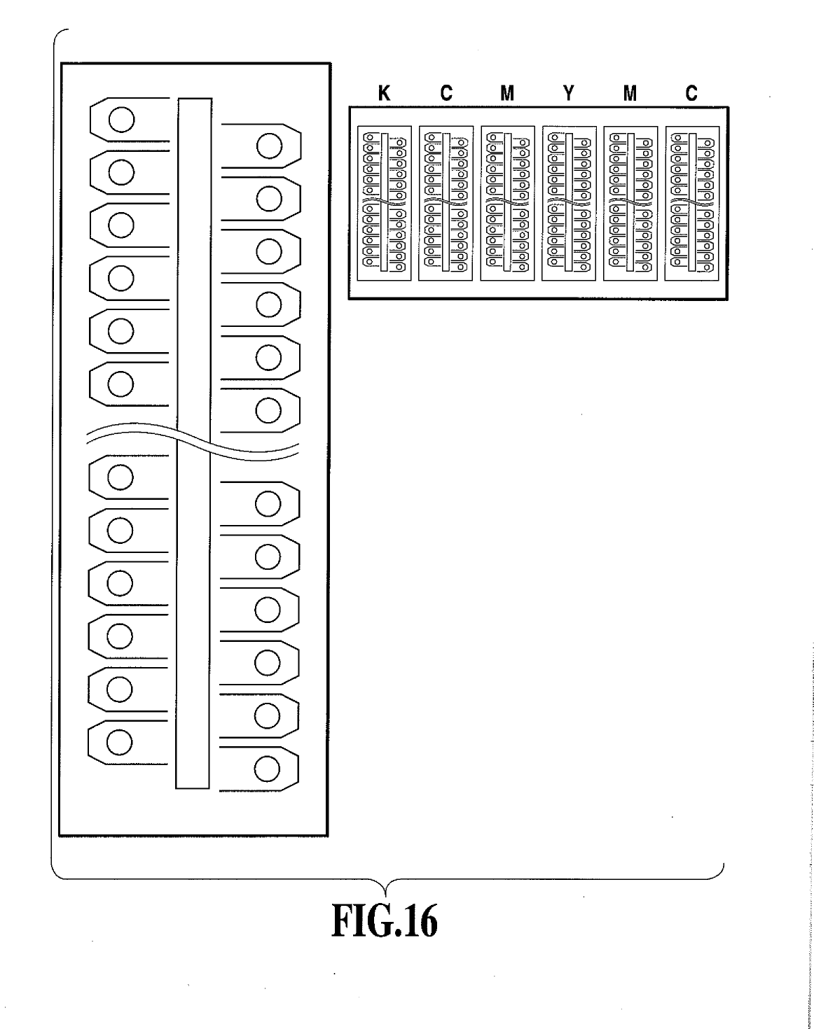

### DESCRIPTION OF THE EMBODIMENTS

Embodiments of the present invention will be described below with reference to the accompanying drawings.

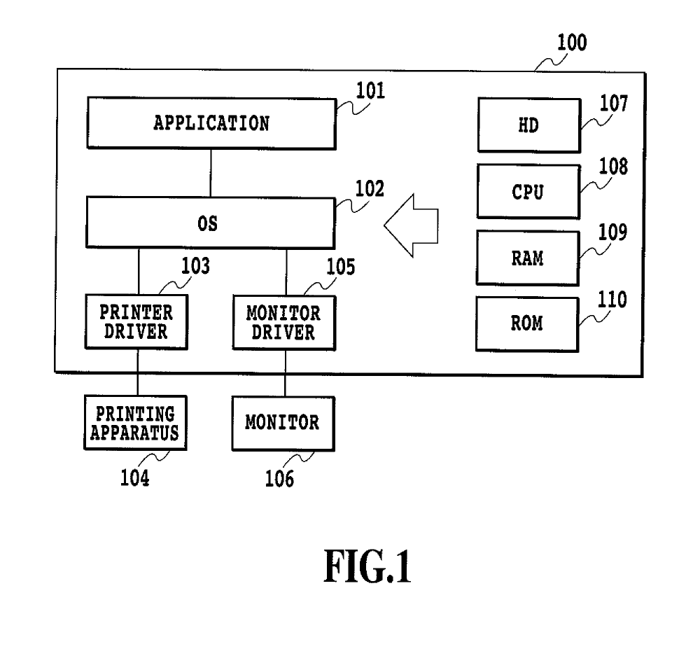

FIG. 1 is a block diagram showing configurations of hardware and software of a personal computer (hereinafter, also referred to as a PC) serving as a host device according to an embodiment of the present invention.

In FIG. 1, a PC 100 serving as a host computer operates each of application software 101, a printer driver 103, and a monitor driver 105 using an operating system (OS) 102.

The application 101 performs processes on a word processor, a spreadsheet, an Internet browser, and the like, and generates image data to be printed by the printing apparatus 104. The monitor driver 105 performs processes such as a creation of image data to be displayed on a monitor 106.

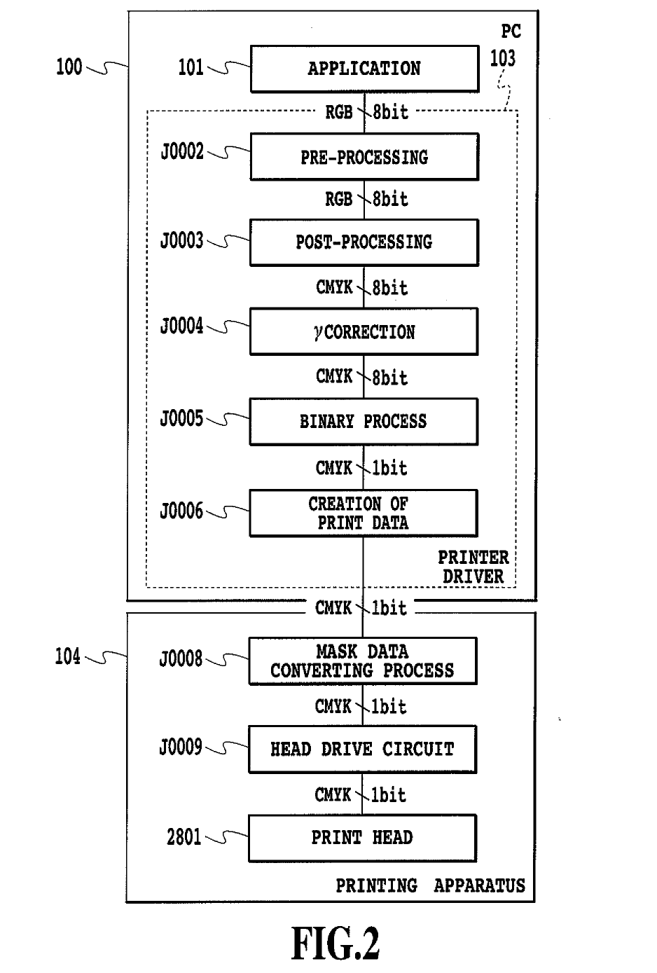

The printer driver 103 performs image processing on a group of various draw commands (an image draw command, a text draw command, a graphics draw command, and the like) which are transmitted from the application 101 to the OS 102, and, finally, expanded into binarized image data which can be processed by the printing apparatus 104. Detailed processes will be described later referring to FIG. 2.

The host computer 100 includes a CPU 108, a hard disk 107, a RAM 109, a ROM 110, and the like as various types of hardware for operating integrated software. The CPU 108 performs processes according to software programs stored in the hard disk 107 and the ROM 110, and the RAM 109 is used as a work area when performing the processes.

The PC 100 of the present embodiment may be configured to function as a data processing apparatus which can fabricate mask patterns in accordance with a print mode, for multi-pass printing by the printing apparatus 104. In this case, fabricated mask pattern data are transferred to the printing apparatus 104, and stored in a memory of the print apparatus 104.

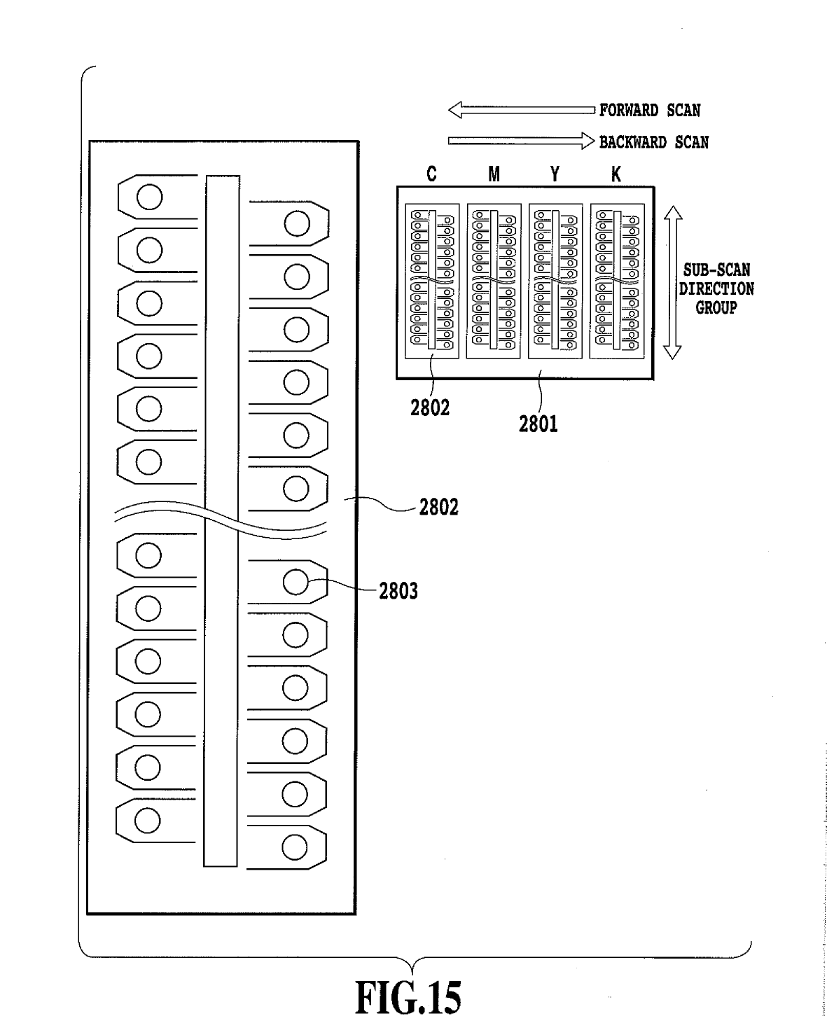

The printing apparatus 104 of the present embodiment is a serial type ink jet printing apparatus which performs printing while scanning a print medium with a print head for ejecting ink. The print head is one which has a configuration having been described in FIG. 15. As for multiple kinds of inks, in this embodiment, i.e. as for four kinds of ink colors which are cyan (C), magenta (M), yellow (Y), and black (B), the print head includes four nozzle rows 2802 which are arranged in parallel to the main scan direction, so that the four nozzle rows 2802 correspond to the above-described four kinds of inks. A print head 2801 is, further, attached to a carriage, and this carriage is scanned in the main scan direction. In FIG. 15, on each nozzle row 2802, multiple ejection openings 2803 are arranged in the sub-scan direction in a density of 1200 dpi (dot/inch), and approximately 3.0 picoliters of ink is ejected.

FIG. 2 is a block diagram for explaining main data processing in the PC 100 and the printing apparatus 104 when printing is performed by the printing apparatus 104 in the configuration shown in FIG. 1. A user can create image data to be printed by the printing apparatus 104, using the application 101. Thereafter, when performing printing, image data created using the application 101 are passed to the printer driver 103.

The printer driver 103 performs pre-processing J0002, post-processing J0003, a γ correction J0004, a binarization process J0005, and a print data creation J0006, respectively.

In the pre-processing J0002, a color range of a display, which displays a screen by an application, is converted into one for the printing apparatus 104. More specifically, image data R, G, and B in which red (R), green (G), and blue (B) are each represented in 8 bits are converted into 8 bit data R, G, and B within the color range of the print apparatus, by using three dimensional LUT.

In the post-processing J0003, colors reproducing the color range thus converted are decomposed into ink colors. More specifically, processes are performed in which 8 bit data C, M, Y, and K are sought so that the data C, M, Y, and K correspond to a combination of inks to reproduce colors represented by the 8 bit data R, G, and B acquired in the pre-processing J0002.

In the γ correction J0004, γ corrections are respectively performed on the 8 bit data CMYK acquired by the color decomposition. More specifically, a linear transformation is performed on a signal value so that each of the 8 bit data CMYK acquired by the color decomposition corresponds linearly to the tone characteristics of the print apparatus 104.

In the binarization process J0005, a digitization process (binarization process) is performed in which the 8 bit data C, M, Y, and K processed with the γ correction are each converted into 1 bit data C, M, Y, and K. One bit data after the conversion are binary data composed of dot print data (1) indicating the printing of dots, and dot non-print data (0) indicating the non-printing of dots.

In the print data creation process J0006 being the final process in the printer driver 103, print data are created by adding print control data and the like to binarized 1 bit image data. The print control data include control information such as “print medium information,” “print quality information,” and a “paper-feeding method.” The print data thus generated are fed to the printing apparatus 104.

The printing apparatus 104 performs a mask data converting process J0008 for binarized image data included in the print data having been inputted. The mask data are binary data in which an allowance and a non-allowance of printing for all pixel data are determined, the all pixel data being able to be printed by the print head 2801 during one print scan, and are stored in advance in a memory of the printing apparatus. In the mask data converting process J0008, a mask pattern is read, and an AND process is performed between the mask pattern and the inputted binary image data. Thus, binary print data are determined, based on which printing (an ejection operation) is actually performed by each print scan in multi-pass printing.

The binary data having been determined to be printed by the mask data converting process J0008 are transferred to a head drive circuit J0009, and timing is set when ink is ejected during the next print scan. Thereafter, the print head 2081 performs an ejection operation according to the timing thus set.

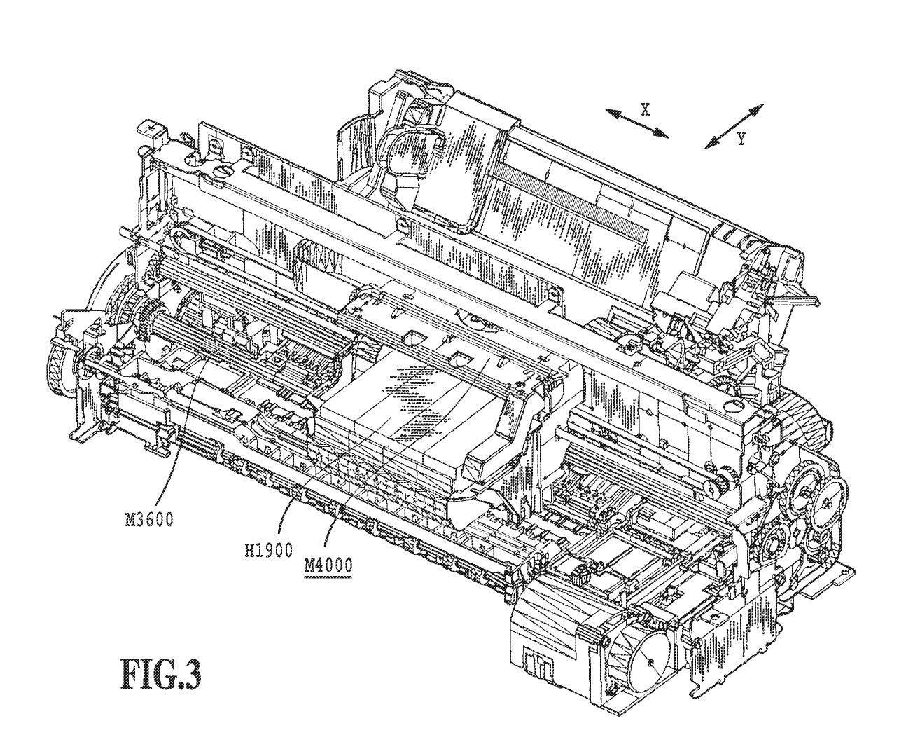

FIG. 3 is a perspective view for explaining an inner configuration of the ink jet printing apparatus 104 which is applied to the present embodiment. With a printer head and an ink tank H1900 which feed inks of cyan (C), magenta (M), yellow (Y), and black (B) to the print head being loaded on a carriage M4000, the carriage M4000 moves in the forward direction or in the backward direction, i.e., in the X direction (in the main scan direction). When the carriage M4000 moves as described above, respective nozzles of the print head eject inks at predetermined timing on the basis of the binarized print data, resulting in that a main print scan in the forward direction or in the backward direction is performed. When one main scan using the print head is terminated, a print medium is fed in the Y direction (in the sub-scan direction) of the drawing by a smaller amount than the width of the nozzle row. Thereafter, the main print scan being the backward scan or the forward scan is performed again. The main print scan in the forward direction or in the backward direction as described above and a feeding operation are alternately repeated, whereby bidirectional multi-pass printing is performed on the print medium.

Features of the present invention reside in a mask pattern used for multiple scans in multi-pass printing, and a multi-pass printing method using the mask pattern. Prior to a description of a discriminative configuration of the present invention, a role of the mask pattern in usual multi-pass printing, and a print state in the case where the mask pattern is used are described.

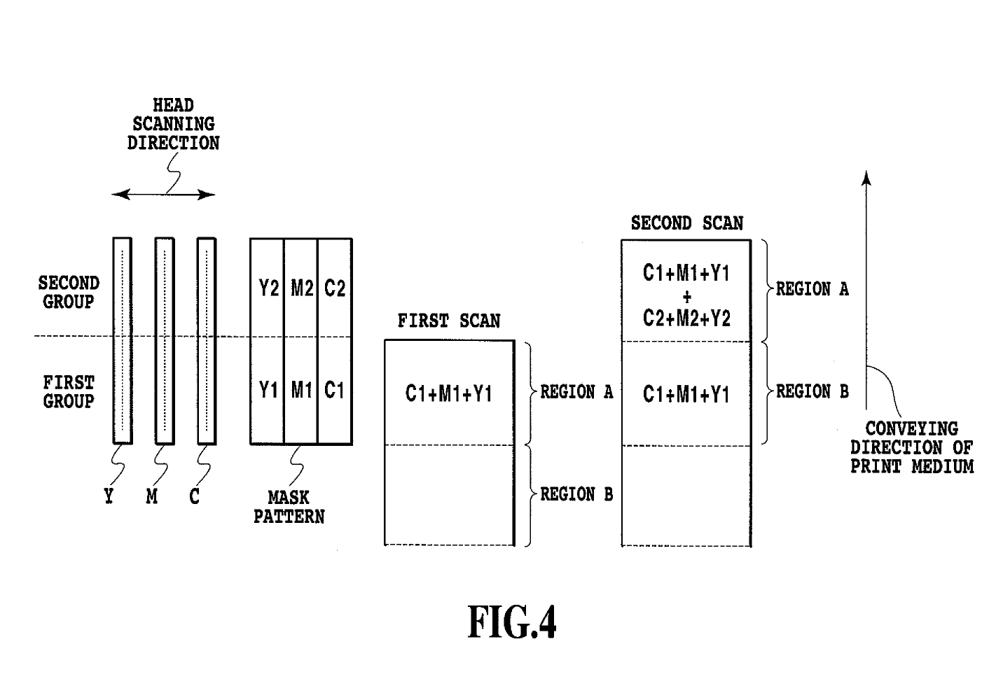

FIG. 4 is a view for schematically explaining a relationship between a print head, a mask pattern, and a print medium in multi-pass printing with two passes. For the sake of simplicity, a description will be given below for the case where an image is formed using three nozzle rows for colors of cyan, magenta, and yellow, each nozzle row having 512 nozzles.

In the case of multi-pass printing with two passes, nozzle rows of respective colors are each divided into two groups, a first group and a second group, each having 256 nozzles. To each of the two groups, allocated are mask patterns having 256 pixels in the sub-scan direction, and a predetermined region (256 pixels, in this case) in the main scan direction; and two types of the mask patterns (for example, Y1 and Y2) allocated to each of the two groups of the same color have a complementary relationship to each other.

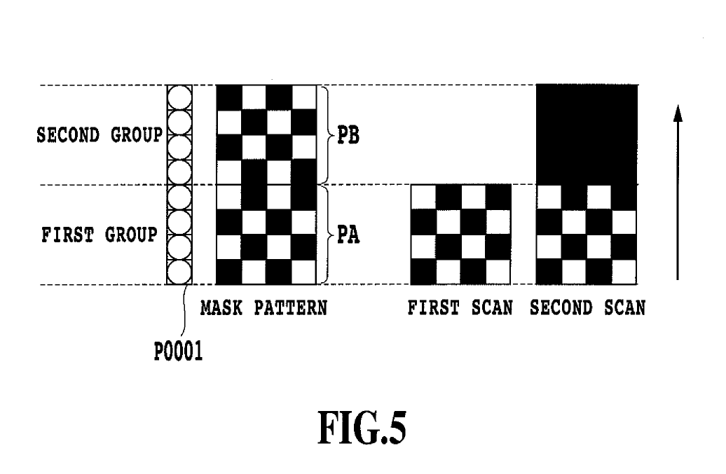

FIG. 5 is a schematic view for briefly explaining mechanisms of mask patterns for two passes which are in a complementary relationship to each other. Hereinafter, for the sake of simplicity, a print head P0001 having 8 nozzles is divided into a first group and a second group, each having 4 nozzles. To each of the two groups, a mask pattern PA and a mask pattern PB, each having a region of four-by-four pixels, are allocated. In the drawing, a region indicated with black denotes a pixel allowing printing, while a region indicated with white denotes a pixel not allowing printing. The mask pattern PA and the mask pattern PB have a reversed relation in the sense that a pixel in which printing is allowed in the mask pattern PA is the pixel in which printing is not allowed in the mask pattern PB, while a pixel in which printing is not allowed in the mask pattern PA is the pixel in which printing is allowed in the mask pattern PB. In other words, an image is printed during two print scans while changing over these two types of mask patterns, whereby all pixels contained in the four-by-four pixels on the print medium are printed.

Referring back to FIG. 4, it can be seen that, the mask patterns of Y1, Y2, M1, M2, C1 and C2 are different from that of PA or PB of FIG. 5 in the size. However, as in the relationship between the mask patterns PA and PB, a relationship between mask patterns Y1 and Y2, a relationship between mask patterns M1 and M2, and a relationship between mask patterns C1 and C2 are each also in a complementary relationship to each other. More specifically, for example, in a region of a print medium in which printing is performed using the mask pattern Y1 by the first scan, printing is performed using the mask pattern Y2 by the second scan, whereby all print data in the region are printed. In an actual printing operation, a feeding operation (sub-scan) of the print medium for 256 pixels is performed between respective scans, so that an image is completed stepwise for each region having a width for 256 pixels on the print medium.

Although the description has been given above for the case of multi-pass printing with two passes as the simplest case, multi-pass printing with three passes or more can be also achieved by adjusting the number of divisions of a nozzle row (the number of groups), a thinning-out rate of print data in a mask pattern, and a feeding amount of a print medium. However, as described in BACKGROUND OF THE INVENTION, when the above-described multi-pass printing is performed in the forward and backward directions, imaging problems referred to as “color banding,” and “time difference unevenness” are newly induced due to a reverse of the order of providing inks, and unevenness of providing timing of inks.

An object of the present invention is to prevent “color banding,” and “time difference unevenness” from occurring in performing bidirectional printing with the minimum number of multi-passes. To make it possible, a discriminative mask pattern devised by the present inventor and the multi-pass printing method will be specifically described.

### First Embodiment

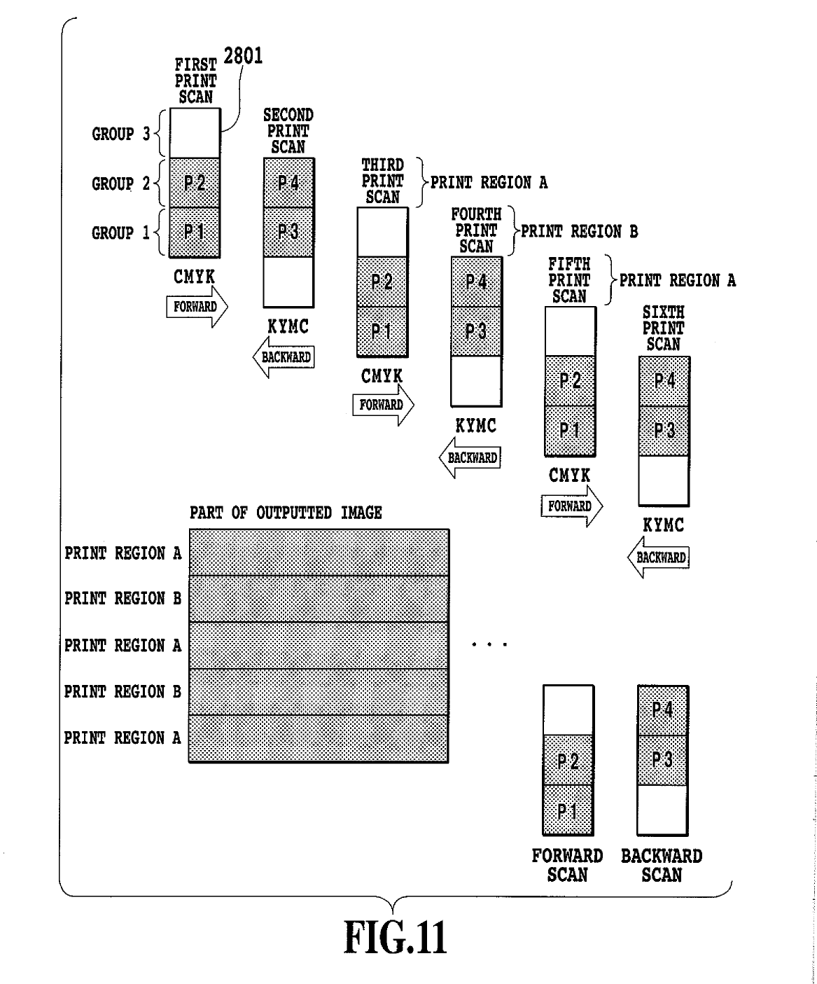

FIG. 11 is a schematic view showing a print state of the print head 2801 at a time when bidirectional multi-pass printing with three passes in a first embodiment is performed. In the case of the multi-pass printing with three passes, a nozzle row of the print head 2801 can be considered with the nozzle row divided into three blocks (parts) from a group 1 to group 3.

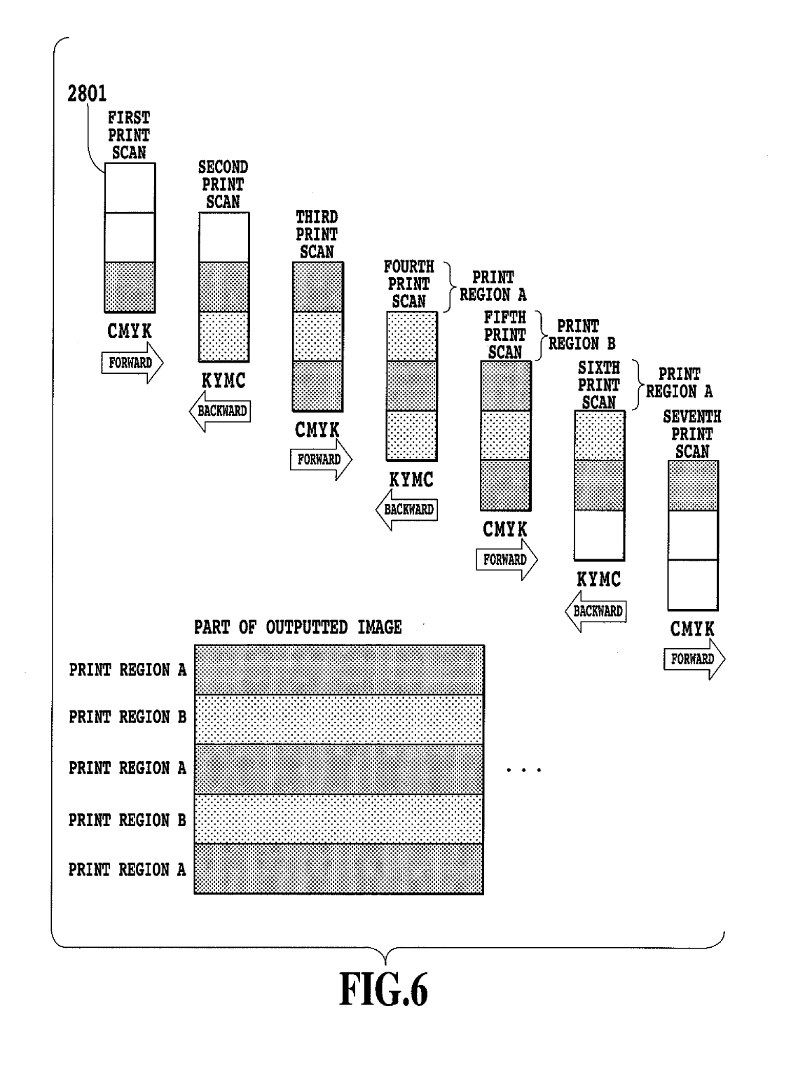

In this embodiment, four types of mask patterns, P1 to P4, are provided for forward and backward scans for the above-described three groups. P1 denotes a mask pattern for the group 1 during the forward scan, and P2 denotes a mask pattern for the group 2 during the forward scan. Meanwhile, P3 denotes a mask pattern for the group 2 during the backward scan, and P4 denotes a mask pattern for the group 3 during the backward scan. The mask patterns P1 and P3 are in a complementary relationship to each other, and the mask patterns P2 and P4 are also in a complementary relationship to each other. In this embodiment, printing is not performed in the group 3 during the forward scan and in the group 1 during the backward scan. Moreover, as in the case of conventional multi-pass printing with three passes described referring to FIG. 6 in BACKGROUND OF THE INVENTION, a feeding operation to be performed between respective scans is performed by a feeding amount corresponding to a length of one-third of the print head 2801.

Considered is a print state in each region (unit region) of a print medium at a time when the above-described bidirectional multi-pass printing with three passes is performed. First of all, paying attention to a print region (unit region) A, it can be seen that, first, ink is provided in the order of cyan→magenta→yellow→black during the first print scan. At this time, ink is also provided to the print region B by the same first scan in the order of cyan→magenta→yellow→black. Following a feeding operation of the print medium, ink is provided in the order of black→yellow→magenta→cyan to the print regions A and B during the second print scan. As described above, with one forward print scan and one backward print scan, printings in the regions A and B are completed simultaneously.

At this time, the orders of providing inks (the orders of printing) in the regions A and B come to exactly the same states. More specifically, in all regions, the orders of providing inks are unified as the order of cyan→magenta→yellow→black→black→yellow→magenta→cyan. Accordingly, “color banding” is avoided, which is viewed as two regions alternately arranged, and in which the orders of providing inks (the orders of printing) are different.

Further, the periods of time elapsed between two print scans to be performed in each region are the same in respective regions on right and left ends. For example, when paying attention to the left end of an image, it can be seen that a period of time corresponding to about one round trip of the print head, which elapsed from the time when ink is provided during the first print scan until the time when ink is provided during the second print scan, becomes comparatively long and the same period of time in the print regions A and B. In addition, when paying attention to the right end of an image, a period of time corresponding to about one inversed operation of the print head, which elapsed from the time when ink is provided during the first print scan until the time when ink is provided during the second print scan, becomes comparatively short and the same period of time in the print regions A and B.

Accordingly, “time difference unevenness” is avoided, which is viewed as two regions alternately arranged in the sub-scan direction, and in which the timings of providing inks during multiple print scans are different.

### Second Embodiment

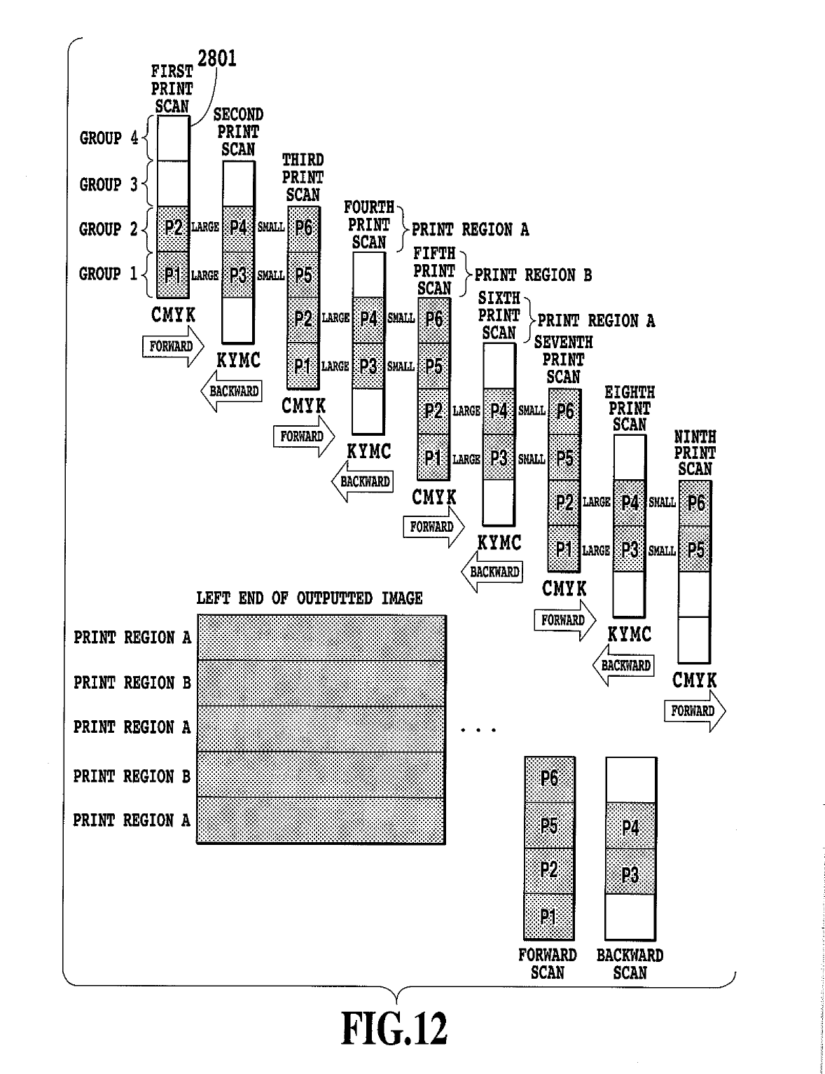

FIG. 12 is a schematic view showing a print state of the print head 2801 at a time when bidirectional multi-pass printing with four passes in a second embodiment is performed. In the case of the multi-pass printing with four passes, a nozzle row of the print head 2801 can be considered with the nozzle row divided into four blocks (parts) from a group 1 to group 4.

In this embodiment, six types of mask patterns, P1 to P6, are provided for forward and backward scans for the above-described four groups. P1 denotes a mask pattern for the group 1 during the forward scan, and P2 denotes a mask pattern for the group 2 during the forward scan. Meanwhile, P3 denotes a mask pattern for the group 2 during the backward scan, and P4 denotes a mask pattern for the group 3 during the backward scan. In addition, P5 denotes a mask pattern for the group 3 during the forward scan, and P6 denotes a mask pattern for the group 4 during the forward scan. The mask patterns P1, P3, and P5 are in complementary relationships to each other, and the mask patterns P2, P4, and P6 are also in complementary relationships to each other. In this embodiment, printing is not performed by the groups 1 and 4 during the backward scan. Moreover, as in the case of conventional multi-pass printing with four passes, a feeding operation to be performed between respective scans is performed by a feeding amount corresponding to a length of a quarter of the print head 2801.

Considered is a print state in each region (unit region) of a print medium at a time when the above-described bidirectional multi-pass printing with four passes is performed. First of all, paying attention to a print region (unit region) A, it can be seen that, first, ink is provided in the order of cyan→magenta→yellow→black during the first print scan. At this time, ink is also provided to the print region B by the same first scan in the order of cyan→magenta→yellow→black. Following a feeding operation of the print medium, ink is provided in the order of black→yellow→magenta→cyan to the print regions A and B during the second print scan. Further, following a feeding operation of the print medium, ink is provided in the order of cyan→magenta→yellow→black to the print regions A and B during the third print scan. As described above, with print scans of two forward scans and one backward scan, printings in the regions A and B are completed simultaneously.

At this time, the orders of providing inks (the orders of printing) in the regions A, B, and all those subsequent thereto come to exactly the same states. More specifically, in all regions, the orders of providing inks are unified as the order of cyan→magenta→yellow→black→black→yellow→magenta→cyan→cyan→magenta→yellow→black. Accordingly, “color banding” is avoided, which is viewed as two regions alternately arranged, and in which the orders of provisions of inks (the orders of printing) are different.

Moreover, the periods of time elapsed between respective scans over each region are the same on right and left ends. For example, when paying attention to the left end of an image, it can be seen that a period of time, which elapsed from the time when ink is provided during the first print scan until the time when ink is provided during the second print scan, is the same in the regions A and B. In addition, a period of time, which elapsed from the time when ink is provided during the second print scan until the time when ink is provided during the third print scan, is also the same in the regions A and B. In other words, in the regions A, B, and all those subsequent thereto, an image is completed with three main print scans in which inks are provided at exactly the same timing. As a result, “time difference unevenness” is avoided, which is viewed as two regions alternately arranged, and in which the timings of providing ink during multiple print scans are different.

### Third Embodiment

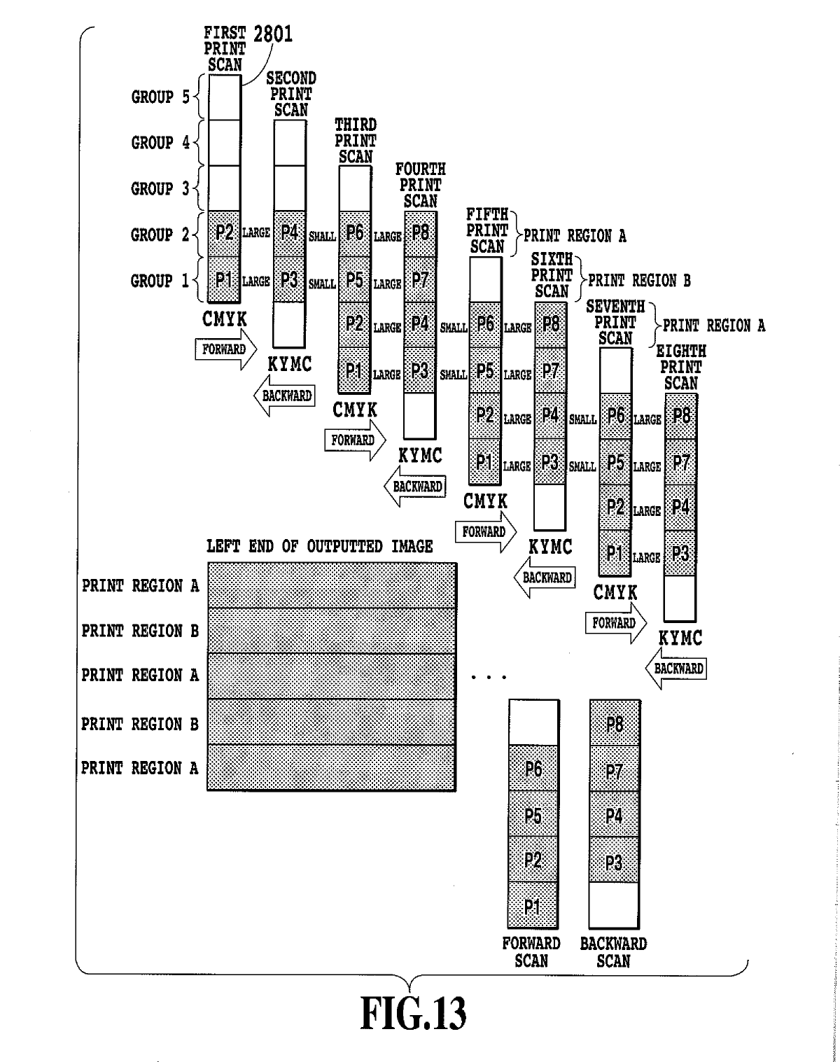

FIG. 13 is a schematic view showing a print state of the print head 2801 at a time when bidirectional multi-pass printing with five passes in a third embodiment is performed. In the case of the multi-pass printing with five passes, a nozzle row of the print head 2801 can be considered with the nozzle row divided into five blocks (parts) from a group 1 to group 5.

In this embodiment, for forward and backward scans for such five groups, eight types of mask patterns, P1 to P8, are provided. P1, P2, P5, and P6 denote mask patterns allocated, respectively, to groups 1, 2, 3, and 4 during the forward scan. P3, P4, P7, and P8 denote mask patterns allocated, respectively, to groups 2, 3, 4, and 5 during the backward scan. The mask patterns P1, P3, P5, and P7 are in complementary relationships to each other, while the mask patterns P2, P4, P6, and P8 are in complementary relationships to each other. In this embodiment, printing is not performed by the group 5 during the forward scan, and by the group 1 during the backward scan. Moreover, as in the case of conventional multi-pass printing with five passes, a feeding operation to be performed between respective scans is performed by a feeding amount corresponding to a length of one-fifth of the print head 2801.

Considered is a print state in each region (unit region) of a print medium at a time when the above-described bidirectional multi-pass printing with five passes is performed. First of all, paying attention to a print region (unit region) A, it can be seen that, first, ink is provided to the above-described region in the order of cyan→magenta→yellow→black during the first print scan. At this time, ink is provided to the print region B during the same first scan in the order of cyan→magenta→yellow→black. Following a feeding operation of the print medium, ink is provided in the order of black→yellow→magenta→cyan to the print regions A and B during the second print scan. Subsequently, following a feeding operation of the print medium, ink is provided in the order of cyan→magenta→yellow→black to the print regions A and B during the third print scan. Further, following a feeding operation of the print medium, ink is provided in the order of black→yellow→magenta→cyan to the print regions A and B during the fourth print scan. As described above, with print scans of two forward scans and two backward scan, printings in the regions A and B are completed simultaneously.

At this time, the orders of providing inks (the order of printing) in the regions A and B come to exactly the same states. More specifically, in all regions, the orders of providing inks are unified as the order of cyan→magenta→yellow→black→black→yellow→magenta→cyan→cyan→magenta→yellow→black→black→yellow→magenta→cyan. Accordingly, “color banding” is avoided, which is viewed as two regions alternately arranged, and in which the orders of provisions of inks (order of printing) are different.

Moreover, the periods of time elapsed between respective scans over each region are the same on right and left ends. For example, when paying attention to the left end of an image, it can be seen that a period of time, which elapsed from the time when ink is provided during the first print scan until the time when ink is provided by the second print scan, is the same in the regions A and B. In addition, a period of time, which elapsed from the time when ink is provided by the second print scan until the time when ink is provided during the third print scan, is also the same in the regions A and B. Further, a period of time, which elapsed from the time when ink is provided during the third print scan until the time when ink is provided during the fourth print scan, is also the same in the regions A and B. In other words, in the regions A and B, an image is completed with four main print scans in which inks are provided at exactly the same timing. As a result, “time difference unevenness” is avoided, which is viewed as two regions alternately arranged, and in which the timings of providing ink during multiple print scans are different.

To confirm effects of three embodiments described above, the inventor has made a validation under the following conditions.

### (Validation Conditions)

Number of nozzles of print head for one color: 786 nozzles

Drive condition of print head: drive frequency 24 KHz

Amount of ejection: 3 pl/dot

### Ink: Color ink BCI7 for ink jet (Canon Inc.)

Carriage scan speed: 20 inch/sec
Carriage inversion time: 0.2 sec
Print resolution: 1200 dpi
Type of print medium: photo paper PR101 for ink jet (Canon Inc.)
Width of print medium: 36 inch
Print image: solid patch of cyan 100%, magenta 100%, and yellow 100% (a condition in which cyan dot, magenta dot and yellow dot are printed in all pixel arranged in 1200 dpi)

Based on the above-described conditions, the inventor has visually checked the image qualities of images printed according to the three embodiments, and images printed bidirectionally using a conventional multi-pass printing method, even with the numbers of multi-passes (3 passes, 4 passes, 5 passes) being the same as those of the three embodiments. It has been confirmed that, for any one of the numbers of multi-passes, “color banding” and “time difference unevenness” are more suppressed in images printed by the embodiments of the present invention, so that preferable images are acquired. In addition, similar results have been obtained for another specialized paper, plain paper, and the like.

In any one of the three embodiments described above, part of a plurality of groups, which are formed by dividing nozzle rows with the number of multi-passes, is set to be in a nonuse state (no ejection) in a predetermined scan direction so as to perform printing. By providing such a region and by suitably changing a mask pattern to be used during the forward scan and the backward scan, it becomes possible to unify the orders of providing inks (the orders of printing), and print timings during multiple print scans between contiguous print regions, and even all over the print regions.

Descriptions have been given above to the three embodiments for the case where each embodiment has a configuration in which printing by multiple groups without one group which placed one end of the print head and printing by multiple groups without one group which placed the other end of the print head, are performed alternately. In other words, in the configuration, part of multiple groups formed by dividing nozzle rows is set to be in a nonuse state (no ejection) in a predetermined scan direction. However, even coming with a little amount of printing, when an allowance rate of printing by mask patterns is suppressed to have a small value so as to be in substantially nonuse, not in completely nonuse (an allowance rate of printing being 0%), an effect of the present invention can be acquired to a greater or lesser extent. According to a study by the present inventors, it has been confirmed that, when the allowance rate of printing on a mask pattern is 10% or less, preferably 5% or less, “color banding” and “time difference unevenness” can be reduced to a certain degree so that they do not become imaging problems.

Further, in the embodiments, one of multiple groups at an end thereof is set to be in nonuse (no ejection), and, for the number of multi-passes being N, N−1 print scans are performed over the same region of a print medium. However, the present invention is not limited to such number of scans, but the configuration of the invention may be one in which an image is formed by performing N−2 or N−3 print scans over the same region. However, an increase in the number of scans not associated with printing has the disadvantage that the increase causes not only a reduction in throughput, but also a reduction in an effect which is originally to create an image of high quality by the multi-pass printing. Therefore, it is preferable that groups of nonuse in each printing scan be small in number.

On the other hand, as in the above embodiments, setting one of the multiple groups at an end thereof to be in nonuse, causes a seam line on a boundary of one in every two print regions to be conspicuous in some cases. In this case, for example, by setting a mask with an allowance rate of printing being 5% or less as described above for the group at an end, it becomes possible to reduce occurrences all of the seam line, “colorbanding,” and “time difference unevenness” in a balanced manner. It is also effective to have a mask pattern which is in gradation so that an allowance rate of printing within a group gradually decreases in a direction toward an end of a print head.

### Fourth Embodiment

Below, a fourth embodiment of the present invention will be described. In this embodiment, it is assumed that the ink jet printing apparatus described referring to FIGS. 1 to 3 has multiple print modes. In accordance with a type of print medium, a use of printed material, a user's preference and the like, one of multiple print modes provided in advance is selected and executed. The multiple print modes are different from each other in the number of multi-passes, a printing direction (one-way printing or bidirectional printing), a type of a print head to be used and the like.

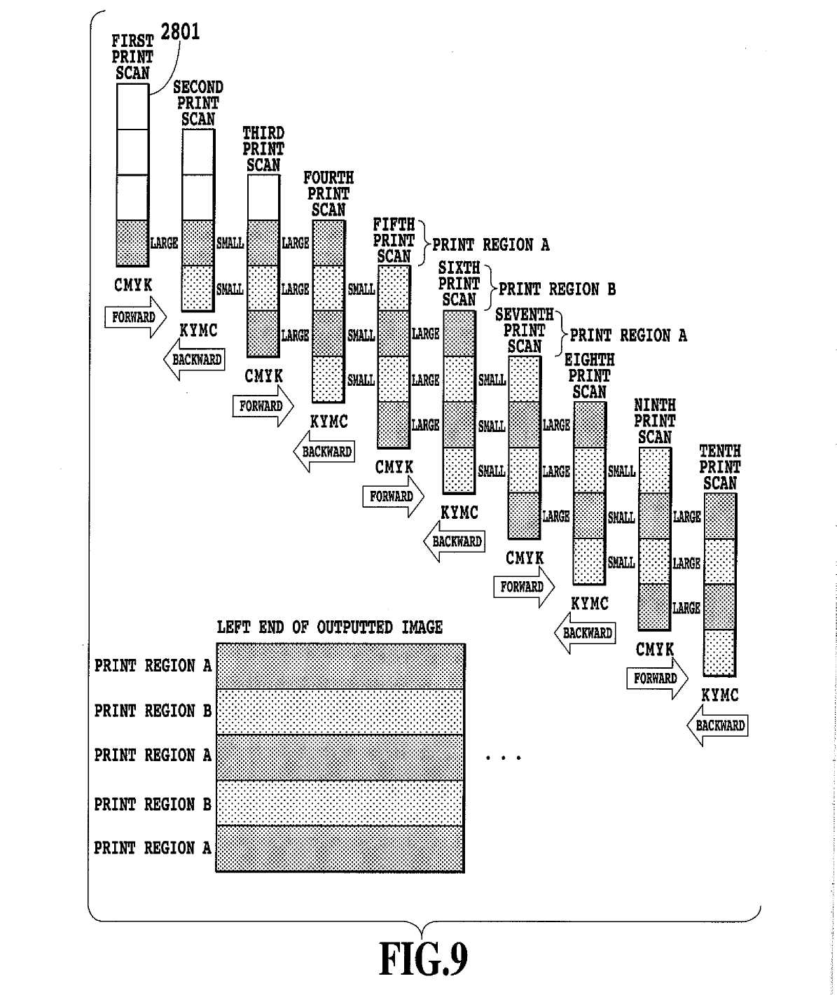

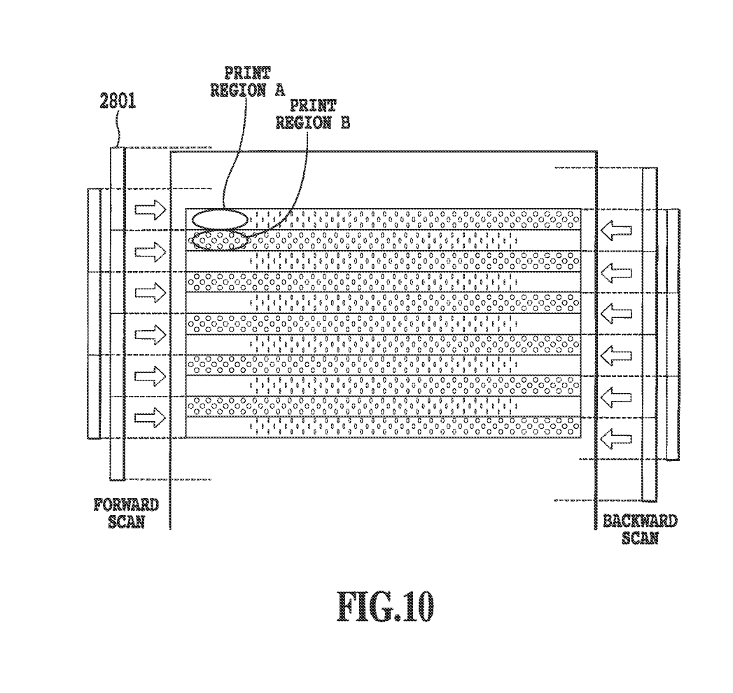

In this embodiment, among multiple print modes, with regard to a print mode in which the number of multi-passes is small, the printing methods described above are adopted, while, with regard to a print mode in which the number of multi-passes is comparatively large, a conventional printing method described with reference to FIGS. 9 and 10 is adopted. More specifically, for example, as for a print mode in which bidirectional multi-pass printing with three passes is performed, the printing method described in the first embodiment is adopted; and as for a print mode in which multi-pass printing with four passes is performed, the multi-pass printing method described in FIGS. 9 and 10 is adopted.

In general, imaging problems due to “color banding” and “time difference unevenness”, which are problems this invention trying to solve, become more conspicuous as the number of multi-passes becomes small, and becomes less visible as the number of multi-passes becomes large. Accordingly, in this embodiment, when the number of multi-passes is small to the degree that “color banding” and “time difference unevenness” are visible, the above-described embodiments are adopted, while, when the number of multi-passes is large on the degree that “color banding” and “time difference unevenness” are not visible, the conventional printing method is adopted, so that a seam line becomes less visible.

Incidentally, the present invention can achieve its effect so long as serial type ink jet printing apparatuses are concerned. Accordingly, inks to be used may be dye ink or pigmented ink. Further, the kinds of ink colors are not limited to four colors described above. For example, the invention achieves its effect even when multiple kinds of colors are used, which contain light cyan and light magenta that contains smaller amount of color materials than usual cyan and magenta, or which contain particular inks such as red, blue and green.

Further, the configuration of a print head is not limited to that shown in FIG. 15. For example, when using a left-right symmetric type print head, the orders of providing inks (the orders of printing) over a print medium by the forward scan and by the backward scan are the same, so that an occurrence of “color banding” can be avoided even without adopting the present invention. Still further, even for a black and white printer on which only a print head ejecting black ink is mounted, “color banding” does not occur. However, even in such a case, the present invention effectively works in that “time difference unevenness” can be reduced.

Yet further, even when using a print head with multiple nozzle rows which eject inks of the same color in different amounts, or even when using a liquid other than an ink along with an ink, the present invention can be adequately applied to these cases. Here, as for a liquid other than an ink, a water-clear reaction liquid may be considered, which coagulates or insolubilizes color materials in an ink. In this case, it is possible, at least, to reduce an occurrence of unevenness due to a time difference for one kind of ink and a reaction liquid.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-346359, filed Dec. 22, 2006 which is hereby incorporated by reference herein in its entirety.

What is claimed is:

1. An ink jet printing method in which printing is performed on a print medium using a print head, including a plurality of nozzle rows that correspond to a plurality of kinds of inks, comprising the steps of:
causing the print head to scan in the manner of a forward scan and a backward scan;
feeding the print medium by a smaller amount of length than a width of the nozzle row between the forward scan and the backward scan; and
performing printing in a unit region having a width of the smaller amount on the print medium by performing a plurality of scans including the forward scan and the backward scan while changing the printing orders of the plurality of kinds of inks between the forward scan and the backward scan,
wherein nozzles to be used in each of the plurality of scans are changed so that the printing orders of the plurality of kinds of inks are the same in all of a plurality of unit regions that are contiguous in the feeding direction.

2. An ink jet printing method in which a first ink and a second ink are ejected through respective nozzle rows corresponding to the first ink and the second ink, arranged in a scanning direction of a print head, by performing a plurality of scans of the print head, the scans including a forward scan and a backward scan, in a plurality of unit regions on a print medium, comprising the steps of:
ejecting inks in an order of the first ink and the second ink through the respective nozzle rows onto the unit region by the forward scan;
ejecting inks in an order of the second ink and the first ink through the respective nozzle rows onto the unit region by the backward scan; and
feeding the print medium by a width of the unit region between the forward scan and the backward scan,
wherein nozzles to be used in each of the plurality of scans are changed so that the printing orders of the first and second inks are the same in any one of the plurality of unit regions.

3. The ink jet printing method according to claim 2, wherein all of the plurality of scans needed to perform printing on one of the unit regions have the same allowable rates of printing on parts of the unit region.

4. An ink jet printing method in which printing is performed on a print medium using a print head, including a nozzle row in which a plurality of nozzles are arranged, comprising the steps of:
dividing the nozzle row into M blocks including some of the nozzles consecutively located (M being a positive integer), and then printing a first unit region among unit regions on the print medium, each of the unit region corresponding to the width of each of the blocks, by performing scans M times including a forward scan and a backward scan;
printing a second unit region contiguous to the first unit region by performing scans M times including a forward scan and a backward scan; and
feeding the print medium by the width of the block between the forward scan and the backward scan,
wherein the first unit region is printed by performing scans M−1 times among the scans to be performed M times, using nozzles contained in M−1 blocks starting from one end of the nozzle row, and the second unit region is printed by performing scans M−1 times among the scans to be performed M times, using nozzles contained in M−1 blocks starting from the other end of the nozzle row.

5. An ink jet printing apparatus in which printing is performed in a unit region on a print medium, the unit region having a smaller width than that of a nozzle row included in a print head, by performing a plurality of scans, including a forward scan and a backward scan, using the print head, comprising:
scanning means which causes the print head to perform forward and backward scans; and
feeding means which feeds the print medium by a smaller amount of length than the width of the nozzle row between the forward and backward scans,
wherein, the order of a forward scan with printing and a backward scan with printing in a first unit region of the unit regions, and the number of scans with printing in the first unit region are the same as those in a second unit region contiguous to the first unit region.

6. An ink jet printing apparatus in which printing is performed in a unit region on a print medium, the unit region having a smaller width than that of a nozzle row included in a print head, by performing a plurality of scans in the unit region using the print head, the scans including a forward scan and a backward scan, comprising:
scanning means which causes the print head to be scanned in the manner of the forward and backward scans; and
feeding means for feeding the print medium by a smaller amount of length than a width of the nozzle row between the forward and backward scans,
wherein a first print mode, and a second print mode in which the number of the plurality of scans is larger than that in the first print mode are executable;
wherein in the first print mode, the order of a forward scan with printing and a backward scan with printing in a first unit region, of the unit regions, and the number of scans with printing are the same as those in a second unit region contiguous to the first unit region, and
in the second print mode, the order of a forward scan with printing and a backward scan with printing in a first unit region is different from those in the second unit region.
